(19) United States
(12) Patent Application Publication
(10) Pub. No.: US 2025/0252774 A1
(43) Pub. Date: Aug. 7, 2025

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: TAKU SATO, Osaka (JP)

(21) Appl. No.: 19/038,010

(22) Filed: Jan. 27, 2025

(30) Foreign Application Priority Data
Feb. 1, 2024 (JP) 2024-014302

(51) Int. Cl. G06V 40/16; G06V 10/82

(52) U.S. Cl. CPC G06V 40/168; G06V 10/82

(57) ABSTRACT

Provided is an information processing apparatus that includes one or more processors and one or more memories storing executable instructions which, when executed by the one or more processors, cause the information processing apparatus to function as a first computation unit configured to perform first transformation, which is local multi-stage feature transformation, and a second computation unit configured to perform second transformation, which is feature transformation wider than that of the first transformation. In the second transformation, at least one of a number of elements and a number of dimensions of a transformed feature are different from that of the first transformation.

### BACKGROUND

### Field

The present disclosure relates to information processing apparatuses and methods for feature transformation.

### Description of the Related Art

There are convolutional neural networks (CNNs) in which feature transformation is performed by repetition of local processing in which weights are shared. Further, for example, there are Vision Transformers (ViTs), which divide input data into a plurality of regions, examine a degree of relevance between the regions, and, based on the degree of relevance, determine which region's feature is to be extracted (Dosovitskiy, Alexey, et al. “An image is worth 16×16 words: Transformers for image recognition at scale.” arXiv preprint arXiv: 2010.11929 (2020)). CNNs and ViTs repeat feature transformation in units of local regions in a plurality of layers and can thereby gradually integrate local features and distinguish a pattern.

Further, in order to promote integration of global and local features of input data, methods in which aggregation (convolution) and decomposition (deconvolution processing and upsampling processing) are repeated sequentially or in stages and which are called feature pyramid networks (Lin, Tsung-Yi, et al. “Feature pyramid networks for object detection.”, Proceedings of the IEEE conference on computer vision and pattern recognition, 2017) and stacked hourglass networks (Newell, Alejandro, Kaiyu Yang, and Jia Deng. “Stacked hourglass networks for human pose estimation.”, Computer Vision-ECCV 2016: 14th European Conference, Amsterdam, The Netherlands, Oct. 11-14, 2016, Proceedings, Part VIII 14. Springer International Publishing, 2016) are widely performed.

In methods such as feature pyramid networks and stacked hourglass networks, a spatial arrangement relationship between features is always maintained, and a degree of freedom of transformation at each stage is small. Therefore, overfitting is unlikely to occur. However, since the number of stages of transformation is large, processing efficiency is poor. Meanwhile, in a method in which fully-connected layers (multilayer perceptron (MLP)) are used, batch transformation is performed without distinction between local and global, and therefore, processing efficiency is good. However, since a degree of freedom of transformation is high, overfitting is likely to occur, and an intended inference result may not be obtained.

### SUMMARY

The present disclosure provides a technique for facilitating integration of local and global features.

According to the first aspect of the present disclosure, there is provided an information processing apparatus that includes one or more processors; and one or more memories storing executable instructions which, when executed by the one or more processors, cause the information processing apparatus to function as a first computation unit configured to perform local multi-stage feature transformation as a first transformation; and a second computation unit configured to perform feature transformation wider than that of the first transformation as a second transformation. In the second transformation, at least one of a number of elements and a number of dimensions of a transformed feature are different from that of the first transformation.

According to the second aspect of the present disclosure, there is provided an information processing method performed by an information processing apparatus, the method including performing a local multi-stage feature transformation as a first transformation; and performing feature transformation wider than that of the first transformation as a second transformation. In the second transformation, at least one of a number of elements and a number of dimensions of a transformed feature are different from that of the first transformation.

According to the third aspect of the present disclosure, there is provided a non-transitory computer-readable storage medium storing a computer program that, when executed by a computer, causes the computer to function as: a first computation unit configured to perform a local multi-stage feature transformation as a first transformation; and a second computation unit configured to perform feature transformation wider than that of the first transformation as a second transformation. In the second transformation, at least one of a number of elements and a number of dimensions of a transformed feature are different from that of the first transformation.

Further features of the present disclosure will become apparent from the following description of exemplary embodiments with reference to the attached drawings.

### BRIEF DESCRIPTION OF THE DRAWINGS

FIG. 1 is a block diagram illustrating an example of a hardware configuration of an information processing apparatus for performing processing for computation in a neural network.

FIG. 2 is a block diagram illustrating an example of a functional configuration of the information processing apparatus, which operates as an inference apparatus.

FIG. 3 is a block diagram illustrating an example of a configuration of a computation unit.

FIG. 4 is a diagram illustrating a specific example of a neural network.

FIG. 5 is a diagram illustrating a course of processing in the neural network.

FIG. 6 is a diagram illustrating a specific example of processing in a reconstruction unit.

FIG. 7 is a diagram illustrating a specific example of the neural network.

FIG. 8 is a diagram illustrating a course of processing in the neural network.

FIG. 9 is a diagram illustrating a specific example of the neural network.

FIG. 10A is a diagram illustrating a method by which a ResNet unit obtains an intermediate feature.

FIG. 10B is a diagram illustrating a method by which the ResNet unit obtains an intermediate feature.

FIG. 11 is a diagram illustrating an example of a configuration of the computation unit.

FIG. 12 is a diagram illustrating a specific example of the neural network.

FIG. 13 is a flowchart for explaining a course of processing in the neural network.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

A neural network that is used in the present embodiment is a hierarchical neural network that includes a layer in which features are aggregated in stages while maintaining a spatial position relationship as in a conventional convolution layer, and a layer in which features are expanded again in a spatial direction using a fully-connected layer. By having such a configuration, the neural network according to the present embodiment can efficiently perform transformation processing.

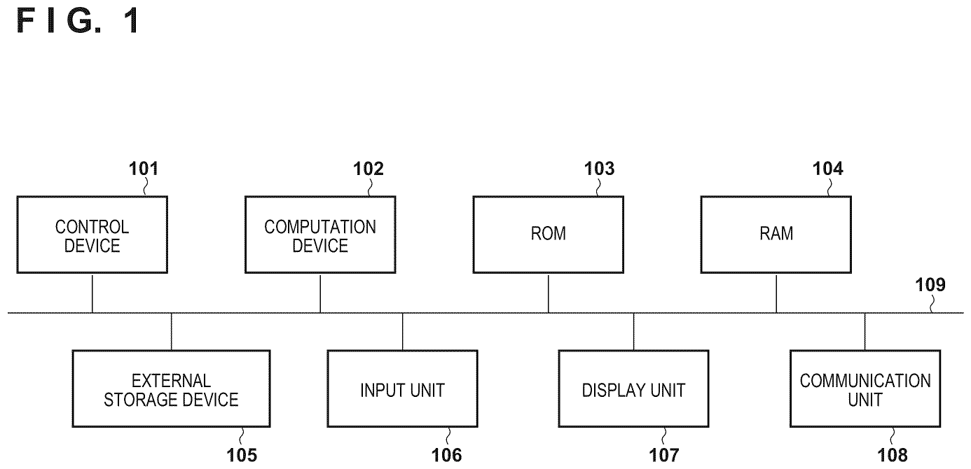

First, an example of a hardware configuration of an information processing apparatus that performs computational processing in the neural network according to the present embodiment will be described with reference to a block diagram of FIG. 1. A computer device, such as a PC, a smartphone, or a tablet terminal device, can be applied to the information processing apparatus according to the present embodiment. The hardware configuration illustrated in FIG. 1 is an example of a hardware configuration applicable to the information processing apparatus and can be appropriately modified or changed.

A control device 101 is a processor such as a central processing unit (CPU) and executes various processes using computer programs and data stored in a RAM 104. The control device 101 thereby performs control of operation of the entire information processing apparatus and executes or controls various processes, which will be described as processing to be performed by the information processing apparatus.

A computation device 102 can be implemented using a graphics processing unit (GPU) or another computational processing circuit and performs various computational processing based on control by the control device 101.

A read only memory (ROM) 103 stores setting data of the information processing apparatus, computer programs and data related to startup of the information processing apparatus, computer programs and data related to a basic operation of the information processing apparatus, and the like.

The random access memory (RAM) 104 includes an area for storing computer programs and data loaded from the ROM 103 and an external storage device 105. Further, the RAM 104 includes an area for storing computer programs and data received from the outside by a communication unit 108. Further, the RAM 104 includes a work area to be used when the control device 101 and the computation device 102 execute various processes. The RAM 104 can thus provide various areas as appropriate.

The external storage device 105 is a large capacity information storage device, such as a hard disk drive. The external storage device 105 stores an operating system (OS), computer programs, data, and the like for causing the control device 101 and the computation device 102 to execute or control various processes, which will be described as processing to be performed by the information processing apparatus.

The external storage device 105 may include a flexible disk (FD) and an optical disk (e.g., a compact disc (CD)), which are removable from the information processing apparatus; a magnetic or optical card; an IC card; a memory card; and the like.

An input unit 106 is a user interface, such as a keyboard, a mouse, a dial, and a touch panel screen, and can input various instructions and information to the information processing apparatus by being operated by a user. The input unit 106 may include various sensors.

A display unit 107 includes a liquid crystal screen or a touch panel screen, and can display results of processing by the control device 101 or the computation device 102, using images, characters, and the like. The display unit 107 may be a projection device such as a projector for projecting images and characters.

The communication unit 108 performs data communication with the outside via a network, such as a LAN and the Internet. The control device 101, the computation device 102, the ROM 103, the RAM 104, the external storage device 105, the input unit 106, the display unit 107, and the communication unit 108 are all connected to a system bus 109.

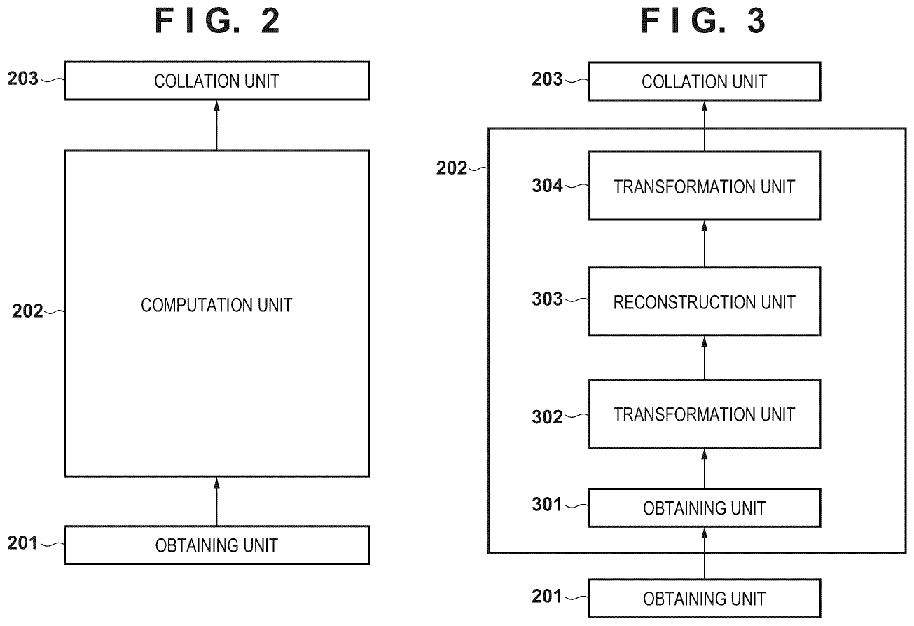

Next, an example of a functional configuration of the information processing apparatus, which operates as an inference apparatus that performs a face authentication task, which is a task for determining whether the face of a person included in one image and the face of a person included in another image are faces of the same person, will be described with reference to a block diagram of FIG. 2. In the present embodiment, a case where each functional unit of FIG. 2 is implemented by software (computer program) will be described. In the following, each functional unit of FIG. 2 will be described as a performer of processing; however, in practice, functions of a functional unit is realized by the control device 101 or the computation device 102 executing a computer program corresponding to that functional unit. Some or all of the functional units of FIG. 2 may be implemented by hardware.

An obtaining unit 201 obtains an image including a person's face. A method by which the obtaining unit 201 obtains an image is not limited to a particular method of obtainment. For example, the obtaining unit 201 may obtain an image stored in the external storage device 105, may obtain an image captured by the input unit 106 serving as an imaging device, or may obtain an image received from the outside by the communication unit 108. The obtaining unit 201 may perform face detection processing on an image including a person's face, identify a region of that face in that image, and obtain an image within that region.

A computation unit 202 computes a facial feature, which is a feature of a person's face from an image obtained by the obtaining unit 201. In the present embodiment, the computation unit 202 inputs an image obtained by the obtaining unit 201 to a neural network and performs computational processing of the neural network, and thereby calculates a facial feature, which is a feature of a person's face in the image. In the present embodiment, a CNN is used as a neural network. A ResNet or the like introduced in K. He, X. Zhang, S. Ren, and J. Sun, “Identity mappings in deep residual networks”, ECCV, 2016 or the like may be used as a structure of the CNN. Alternatively, a neural network that is described in Alexey Dosovitskiy, et al., “An image is worth 16×16 words: Transformers for image recognition at scale”, ICLR, 2021 and known as a Vision Transformer (ViT) may be used. The structure of the neural network is not limited to these but is a structure in which a method to be described later is provided therein.

A collation unit 203 collates a facial feature calculated by the computation unit 202 for one image obtained by the obtaining unit 201 and a facial feature calculated by the computation unit 202 for another image obtained by the obtaining unit 201. Then, for example, if a degree of similarity between the respective collated facial features is a threshold or more, the collation unit 203 determines that the face of a person in one image and the face of a person in another image are faces of the same person. Meanwhile, if a degree of similarity between the respective collated facial features is less than a threshold, the collation unit 203 determines that the face of a person in one image and the face of a person in another image are not faces of the same person. Then, the collation unit 203 outputs a result of that determination as a result of face recognition. A form in which a result of face recognition is outputted is not limited to a specific form of output. For example, the collation unit 203 may display a result of face authentication on the display unit 107, using images and characters, or may transmit a result of face authentication to the outside by the communication unit 108.

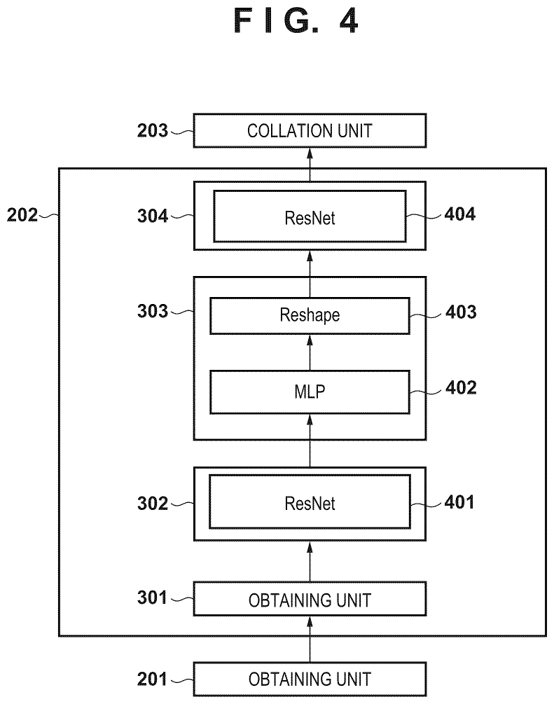

Next, an example of a configuration of the computation unit 202 will be described with reference to a block diagram of FIG. 3. An obtaining unit 301 applies pre-processing to an image obtained by the obtaining unit 201 and generates, as a face image, an image that is in a format that can be inputted to a subsequent transformation unit 302. For example, the obtaining unit 301 identifies a region of a person's face from an image obtained by the obtaining unit 201, using a well-known technique. The obtaining unit 301 performs processing, such as cropping, resizing, and normalization, on an image in that region according to an input format of the subsequent transformation unit 302 and generates, as a face image, an image to be inputted to the transformation unit 302.

The transformation unit 302 inputs the face image generated by the obtaining unit 301 to a neural network and performs computational processing in the neural network, and thereby applies feature transformation to the face image and calculates, as a result of that computational processing, a facial feature, which is a feature of a person's face in the face image. As the neural network used by the transformation unit 302 to calculate a facial feature, a CNN, for example, can be used. As a structure of the CNN, a ResNet or the like introduced in K. He, X. Zhang, S. Ren, and J. Sun, “Identity mappings in deep residual networks”, In ECCV, 2016 or the like may be used. Further, for example, as the neural network used by the transformation unit 302 to calculate a facial feature, a neural network that is described in Alexey Dosovitskiy, et al., “An image is worth 16×16 words: Transformers for image recognition at scale”, ICLR, 2021, known as a Vision Transformer (ViT), may be used.

In a conventional method, collation is performed using the facial feature obtained by the transformation unit 302. In contrast, in the present embodiment, the reconstruction unit 303 and a transformation unit 304 are applied in order to increase the efficiency of feature transformation.

The reconstruction unit 303 applies processing, which includes rearrangement of a matrix, on the facial feature calculated by the transformation unit 302, and thereby optimizes the facial feature without being bound to spatial position. The transformation unit 304 inputs the facial features optimized by the reconstruction unit 303 to a neural network and performs computational processing of the neural network, and thereby applies feature transformation processing to the facial feature. Similar to the transformation unit 302, the transformation unit 304 can use a neural network, such as a ResNet or a ViT, for example, as the neural network. However, the neural network used by the transformation unit 304 need not be a neural network having the same structure as the neural network used by the transformation unit 302.

The collation unit 203 collates a facial feature obtained by the transformation unit 304 for one image obtained by the obtaining unit 201 and a facial feature obtained by the transformation unit 304 for another image obtained by the obtaining unit 201.

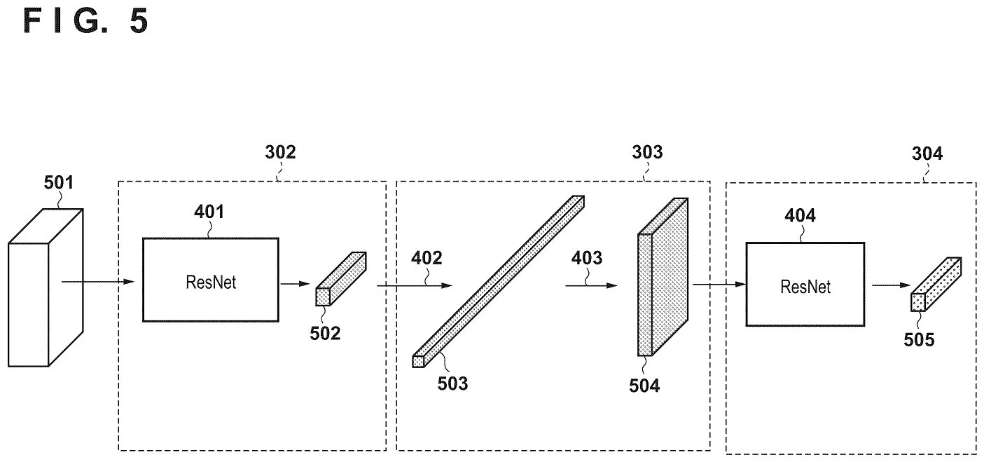

Next, a specific example of a neural network according to the present embodiment will be described with reference to FIG. 4. The transformation unit 302 inputs a face image to a ResNet 401 and performs computational processing of the ResNet 401, and thereby calculates a facial feature.

The reconstruction unit 303 inputs the facial feature calculated using the ResNet 401 into an MLP 402, which performs linear transformation processing, and performs computational processing of the MLP 402, and thereby transforms the facial feature.

Further, the reconstruction unit 303 inputs the facial feature transformed by the MLP 402 to Reshape 403, which performs matrix shape transformation processing, and performs computational processing of Reshape 403, and thereby transforms the facial feature. The transformation unit 304 inputs the facial feature transformed by Reshape 403 to a ResNet 404 and performs computational processing of the ResNet 404, and thereby transforms the facial feature.

The collation unit 203 collates a facial feature obtained by the ResNet 404 for one image obtained by the obtaining unit 201 and a facial feature obtained by the ResNet 404 for another image obtained by the obtaining unit 201.

The structure of the ResNet 401 and the structure of the ResNet 404 may or may not be the same. For example, the size of each of the ResNet 401 and the ResNet 404 may be individually adjusted taking computational resources into consideration. For example, the number of layers of the ResNet 401 may be greater than the number of layers of the ResNet 404. Further, for example, one or both of the ResNet 401 and the ResNet 404 may be replaced with a ViT.

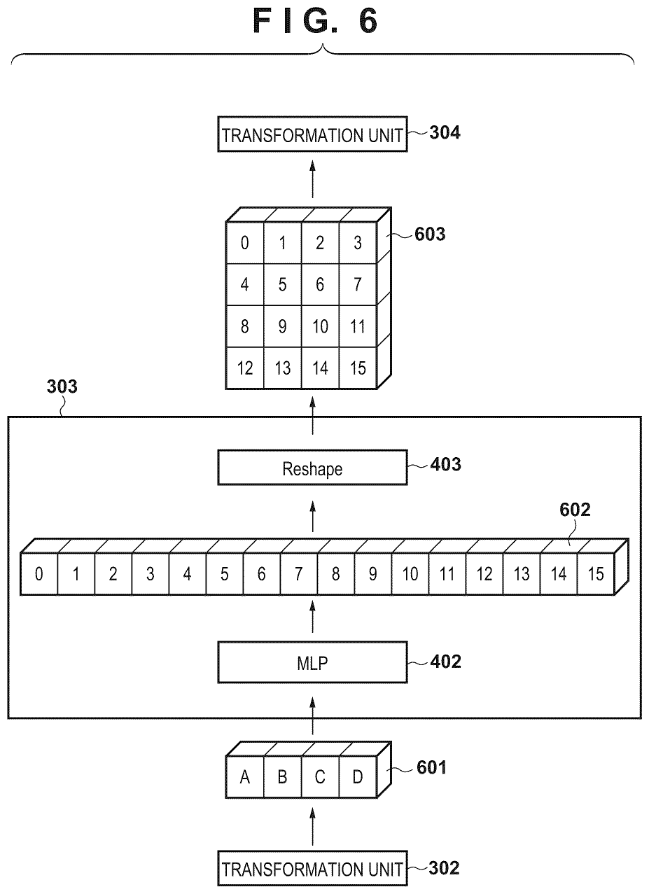

Next, a course of processing in the neural network according to the present embodiment will be described with reference to FIG. 5. The transformation unit 302 inputs a face image 501 to the ResNet 401 and performs computational processing (feature transformation) of the ResNet 401. With this, similar to a typical neural network for obtaining a feature, the transformation unit 302 gradually reduces the resolution of a facial feature in the course of feature transformation and finally calculates a one-dimensional tensor feature 502 as a facial feature. If it is desired to increase the accuracy of processing of a trained neural network having such a structure, processing for performing further feature transformation on the one-dimensional tensor feature 502 may be considered. For example, transformation with a fully-connected layer (MLP) is applicable. However, feature transformation with a MLP is free from constraints such as weight sharing of a convolutional neural network and is accordingly superior in performance of arbitrary transformation approximation but is prone to overfitting.

Therefore, in the present embodiment, the reconstruction unit 303 is introduced with a purpose of applying, to the one-dimensional tensor feature 502, a neural network, such as a ResNet, which is not prone to overfitting and is efficient in processing.

The reconstruction unit 303 inputs the one-dimensional tensor feature 502 to the MLP 402 and performs computational processing (linear transformation processing) of the MLP 402, and thereby calculates a one-dimensional tensor feature 503 obtained by increasing the number of elements of the one-dimensional tensor feature 502.

Next, the reconstruction unit 303 inputs the one-dimensional tensor feature 503 to Reshape 403 and performs computational processing of Reshape 403. The reconstruction unit 303 thereby shapes the one-dimensional tensor feature 503 and calculates a “three-dimensional facial feature 504, which is a three-dimensional facial feature,” obtained by increasing the number of dimensions of the one-dimensional tensor feature 503.

The transformation unit 304 inputs the three-dimensional facial feature 504 to the ResNet 404 and performs computational processing of the ResNet 404, and thereby calculates a final output feature 505, which is a one-dimensional tensor feature.

The collation unit 203 collates the final output feature 505 obtained by the ResNet 404 for one image obtained by the obtaining unit 201 and the final output feature 505 obtained by the ResNet 404 for another image obtained by the obtaining unit 201.

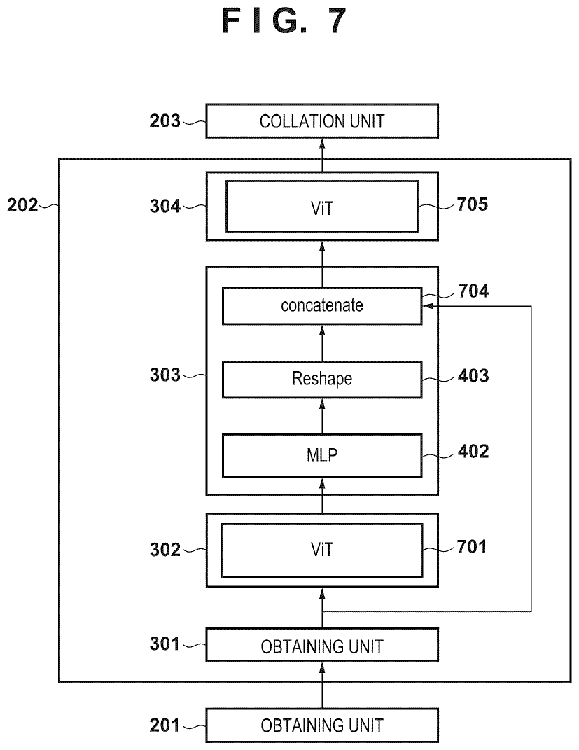

Next, a specific example of processing in the reconstruction unit 303 will be described with reference to FIG. 6. FIG. 6 illustrates processing in which the reconstruction unit 303 transforms a one-dimensional tensor feature that includes four elements into a three-dimensional facial feature represented as a matrix having a 4×4×1 shape. The transformation unit 302 calculates a one-dimensional tensor feature 601, which includes four elements, from a face image.

The reconstruction unit 303 inputs the one-dimensional tensor feature 601 to the MLP 402 and performs computational processing (linear transformation processing) of the MLP 402, and thereby calculates a one-dimensional tensor feature 602, which includes 16 elements. The one-dimensional tensor feature 602, which includes 16 elements, is calculated by a respective individual linear transformation parameter being applied to each element of the one-dimensional tensor feature 601, which includes four elements.

Then, the reconstruction unit 303 inputs the one-dimensional tensor feature 602 to Reshape 403 and performs computational processing of Reshape 403, and thereby rearranges respective elements of the one-dimensional tensor feature 602 and calculates a 4×4×1 three-dimensional facial feature 603. FIG. 6 simply illustrates a case where the 4×4×1 three-dimensional facial feature 603 is calculated by extracting four elements at a time from the first element of the one-dimensional tensor feature 602 and arranging them in a column direction.

The reconstruction unit 303 thus transforms a one-dimensional tensor feature into a three-dimensional feature, which is a feature in a format that can be inputted to the transformation unit 304. Although FIG. 6 illustrates an example in which a one-dimensional tensor feature that includes four elements is transformed into a feature represented by a 4×4×1 matrix, the data format is not limited thereto, and the reconstruction unit 303 can perform any shape transformation in accordance with the data formats of the transformation unit 302 and the transformation unit 304.

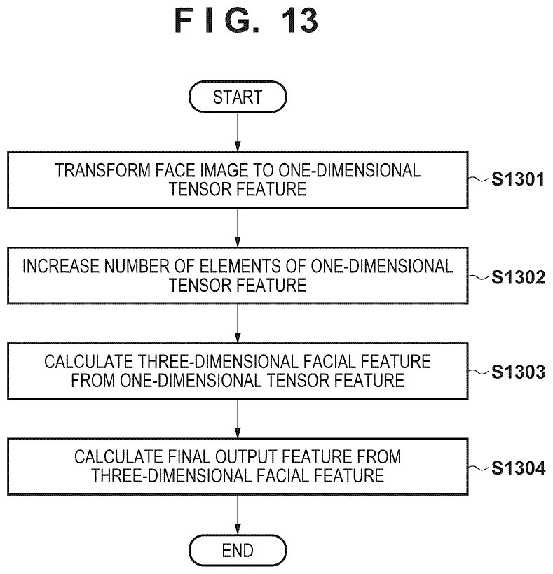

A course of processing in the neural network according to the present embodiment will be described in accordance with a flowchart of FIG. 13. The details of processing in each step of FIG. 13 are as described above.

In step S1301, the transformation unit 302 performs feature transformation of the face image 501 and calculates the one-dimensional tensor feature 502 as a facial feature. In step S1302, the reconstruction unit 303 calculates the one-dimensional tensor feature 503 obtained by increasing the number of elements in the one-dimensional tensor feature 502.

In step S1303, the reconstruction unit 303 calculates the three-dimensional facial feature 504 obtained by increasing the number of dimensions of the one-dimensional tensor feature 503. In step S1304, the transformation unit 304 performs feature transformation of the three-dimensional facial feature 504, and thereby calculates the final output feature 505.

Next, a method of inference and learning in the neural network according to the present embodiment will be described with reference to FIG. 5 again. In a conventional method, at the time of inference, feature transformation is performed on the face image 501 using only the transformation unit 302, the one-dimensional tensor feature 502 is thereby obtained, and the one-dimensional tensor feature 502 calculated for one image and the one-dimensional tensor feature 502 calculated for another image are collated. Further, at the time of training, loss is calculated using the one-dimensional tensor feature 502.

Meanwhile, in the present embodiment, the reconstruction unit 303 and the transformation unit 304 are added in addition to the transformation unit 302 (ResNet 401), which has been trained in advance using a conventional training method as described above. Here, what is obtained by connecting the transformation unit 302, the reconstruction unit 303, and the transformation unit 304 is treated as one new feature extraction model.

At the time of inference of the neural network according to the present embodiment, the information processing apparatus performs feature transformation on the face image 501 using the transformation unit 302, the reconstruction unit 303, and the transformation unit 304, calculates the final output feature 505, and performs collation as described above using the final output feature 505.

At the time of training the neural network according to the present embodiment, the information processing apparatus calculates error (loss) between the final output feature 505 and a feature that is teacher data corresponding to the face image 501 and updates parameters of the neural network so as to reduce error. The error can be propagated back to the input layer of the transformation unit 302. However, in the present embodiment, parameters of a pre-trained transformation unit 302 (ResNet 401) are not updated, and parameters of the reconstruction unit 303 (MLP 402 and Reshape 403) and the transformation unit 304 (ResNet 404) are trained. With this, training can be performed faster than when all parameters are trained at once. Further, since further feature transformation is performed on an output of the transformation unit 302, the processing accuracy of the neural network is higher than that in which inference is performed by the transformation unit 302 alone. However, the training method is not limited thereto, and training may be performed with the transformation unit 302 included.

Finally, effects obtained by the above processing procedure will be described. In a conventional method, a typical neural network gradually reduces the resolution of a feature in the course of feature transformation and finally obtains a one-dimensional tensor feature. If it is desired to increase the accuracy of processing of a trained neural network having such a structure, processing for performing further feature transformation on a one-dimensional tensor feature may be considered. For example, transformation in which a fully-connected layer (MLP) is used can be applied, but overfitting is likely to occur.

Meanwhile, in the present embodiment, the reconstruction unit 303 transforms the shape of a one-dimensional tensor feature and allows another application of a neural network such as ResNet. Generally, a neural network such as ResNet is less prone to overfitting than a neural network that consists only of fully-connected layers, even if the number of layers and the number of parameters are increased. Therefore, it is possible to add a neural network that is larger than what is conventional to a learned model and increase the accuracy of processing of the neural network.

As described with reference to FIG. 6, the reconstruction unit 303 may increase the number of dimensions of a one-dimensional tensor feature by linear transformation with independent parameters. When increasing the number of dimensions of a feature, in conventional methods, such as feature pyramid networks and stacked hourglass networks, for example, redundant processing is performed, in particular, for example, deconvolution processing in which a feature is enlarged simply by inserting components, which are zeros. Meanwhile, in the present embodiment, since linear transformation with independent parameters is applied, processing efficiency of the neural network is better than that of redundant processing, such as deconvolution processing.

Further, in typical feature transformation, a spatial position relationship between features is maintained, that is, a spatial arrangement of respective elements of a feature remains undisrupted before and after feature transformation. For example, an upper left element of a feature is associated with an upper left region of an input image from start to finish, regardless of how many times feature transformation is repeated. Although such a constraint has an effect of simplifying training, only a feature that is related to a spatial position relationship can be extracted. In contrast, since the reconstruction unit 303 performs processing for replacing arbitrary matrix elements, it is possible to extract features which are missed in feature transformation processing with constraints on a spatial position relationship. At the same time, since the reconstruction unit 303 holds learning parameters, an effect of optimizing a feature such that the subsequent transformation unit 304 can efficiently perform feature transformation in combination with the above processing for replacing arbitrary matrix elements can be expected.

As described above, in the present embodiment, a neural network with high processing accuracy and efficiency can be applied as an additional feature transformation unit. Further, by fixing the weights of the transformation unit 302 (ResNet 401) and training only the transformation unit 304 (ResNet 404), it is possible to maintain the tendency of output of the transformation unit 302.

### Second Embodiment

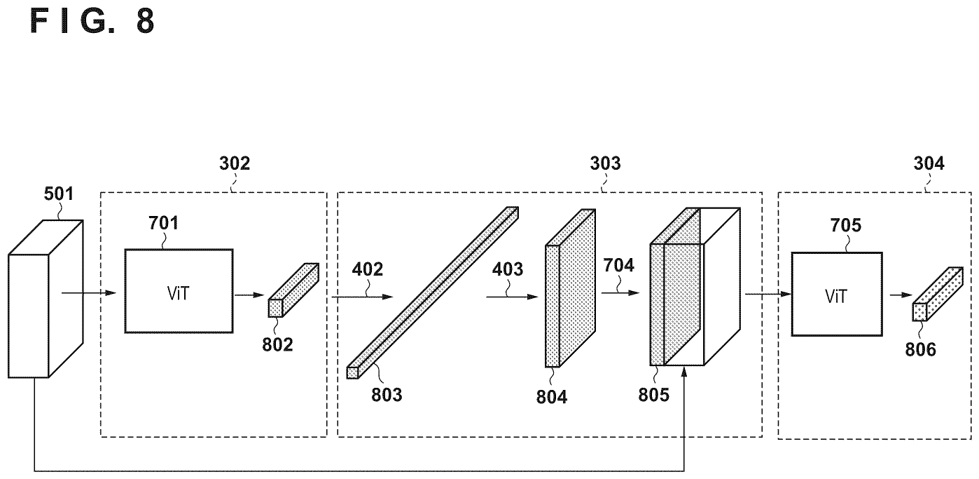

In each of the following embodiments including the present embodiment, differences from the first embodiment will be described, and unless otherwise mentioned below, they are assumed to be similar to the first embodiment. In the first embodiment, a case where the transformation unit 302 and the transformation unit 304 use a ResNet has been described. Further, in the first embodiment, the reconstruction unit 303 only takes, as input, output (one-dimensional tensor feature 502) from the transformation unit 302. In contrast, a specific example of a neural network according to the present embodiment will be described with reference to FIG. 7.

In the present embodiment, the transformation unit 302 and the transformation unit 304 use a ViT. Further, in the present embodiment, the reconstruction unit 303 takes, as input, the face image 501, in addition to output (one-dimensional tensor feature 502) from the transformation unit 302.

Further, in the present embodiment, a case where the information processing apparatus executes an arbitrary object detection task, which is a task of detecting an object from an image, will be described. The input of an arbitrary object detection task is an image that includes an object to be detected. The output of an arbitrary object detection task is a position (detection coordinates) of a frame (detection frame) surrounding an object detected in an image and a size (vertical/horizontal size) of that detection frame.

The transformation unit 302 inputs a face image generated by the obtaining unit 301 to a ViT 701 and performs computational processing of the ViT 701, and thereby calculates a facial feature. The reconstruction unit 303 inputs the facial feature calculated using the VIT 701 to the MLP 402 and performs computational processing of the MLP 402, and thereby transforms the facial feature. Then, the reconstruction unit 303 inputs the facial feature transformed by the MLP 402 to Reshape 403 and performs computational processing of Reshape 403, and thereby transforms the facial feature. Then, the reconstruction unit 303 inputs the facial feature transformed by Reshape 403 and the facial image generated by the obtaining unit 301 to concatenate 704 and performs computation of concatenate 704. The reconstruction unit 303 obtains the face image generated by the obtaining unit 301 by skip connection (shortcut connection). The reconstruction unit 303 thereby generates, as an “optimized feature”, concatenated information obtained by concatenating the facial feature transformed by Reshape 403 and the facial image generated by the obtaining unit 301. Processing other than concatenate may be applied. For example, an element-wise product or addition, and the like of a facial feature and a facial image may be applied. That is, so long as a feature obtained by merging a facial feature and a facial image can be generated as an “optimized feature”, various methods, such as concatenation, element-wise product, and addition, can be applied as the method of merging. The transformation unit 304 inputs the feature generated by concatenate 704 to a ViT 705 and performs computational processing of the VIT 705, and thereby transforms the feature.

The structure of the ViT 701 and the structure of the VIT 705 may or may not be the same. For example, the size of each of the VIT 701 and the VIT 705 may be individually adjusted taking computational resource into consideration. Further, for example, one or both of the VIT 701 and the VIT 705 may be replaced with a ResNet.

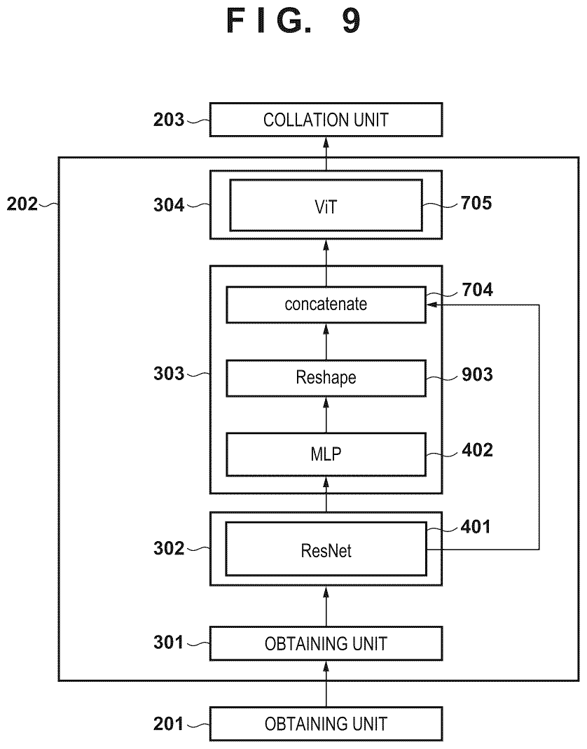

Next, a course of processing in the neural network according to the present embodiment will be described with reference to FIG. 8. The transformation unit 302 inputs the face image 501 to the VIT 701 and performs computational processing (feature transformation) of the VIT 701, and thereby calculates a one-dimensional tensor feature 802 as a facial feature.

The reconstruction unit 303 inputs the one-dimensional tensor feature 802 to the MLP 402 and performs computational processing (linear transformation processing) of the MLP 402, and thereby calculates a one-dimensional tensor feature 803 obtained by increasing the number of elements of the one-dimensional tensor feature 802.

Then, the reconstruction unit 303 inputs the one-dimensional tensor feature 803 to Reshape 403 and performs computational processing of Reshape 403, and thereby calculates a “three-dimensional facial feature 804, which is a three-dimensional facial feature,” obtained by increasing the number of dimensions of the one-dimensional tensor feature 803.

Then, the reconstruction unit 303 inputs the three-dimensional facial feature 804 and the face image 501 to concatenate 704 and performs computation of concatenate 704, and thereby generates, as a feature 805, concatenated information obtained by concatenating the three-dimensional facial feature 804 and the face image 501. Since information that has fallen out in the course of feature transformation of the VIT 701 can be obtained again by concatenate 704, accuracy of processing of the neural network improves.

The transformation unit 304 inputs the feature 805 to the VIT 705 and performs computational processing of the ViT 705, and thereby calculates a final output feature 806, which is a one-dimensional tensor feature. The collation unit 203 collates the final output feature 806 obtained by the VIT 705 for one image obtained by the obtaining unit 201 and the final output feature 806 obtained by the ViT 705 for another image obtained by the obtaining unit 201.

Similar to the first embodiment, the above neural network is treated as one feature transformation model that transforms a feature of the face image 501 and outputs the final output feature 806, and training and inference methods conform to those of the first embodiment.

In the present embodiment, in addition to the effects obtained in the first embodiment, even if information is lost in the course of feature transformation, concatenate 704 complements the lost information; therefore, there is an effect of improvement in accuracy of processing of the neural network.

### Third Embodiment

In the second embodiment, the reconstruction unit 303 obtains the face image 501 by shortcut connection and concatenates output of the transformation unit 302 and the face image 501. However, a configuration may be taken so as to obtain an intermediate feature of the transformation unit 302 by shortcut connection and concatenate output of the transformation unit 302 and the intermediate feature. Further, in the above embodiments, a case of application in a face recognition or arbitrary object detection task has been described, but application in other tasks may be performed.

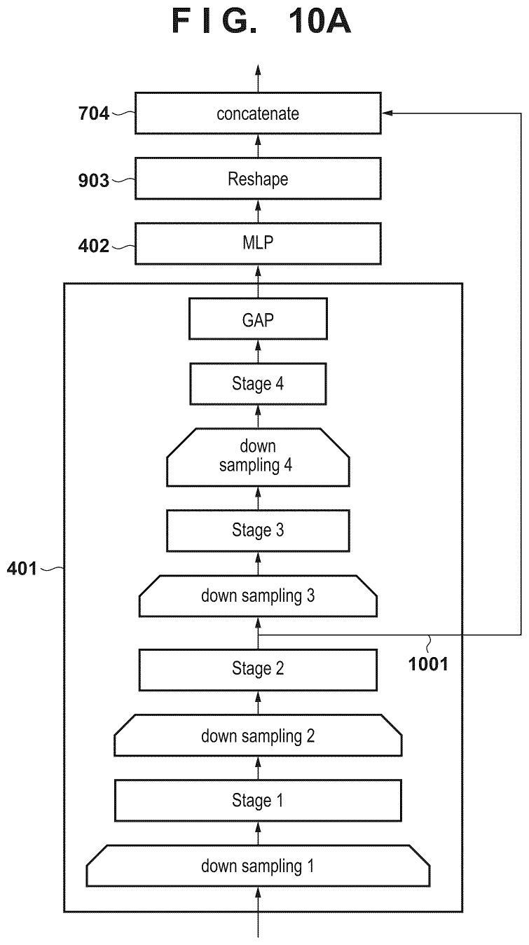

A specific example of a neural network according to the present embodiment will be described with reference to FIG. 9. Further, in the present embodiment, a case where the information processing apparatus executes a human pose estimation task, which is a task of estimating a pose of a human included in an image, will be described. The input of a human pose estimation task is an image including a person to be a target of pose estimation. The output of a human pose estimation task is positions of joints of a person included in an image.

The transformation unit 302 inputs a face image to the ResNet 401 and performs computational processing of the ResNet 401, and thereby calculates a facial feature. The reconstruction unit 303 inputs the facial feature calculated using the ResNet 401 to the MLP 402 and performs computational processing of the MLP 402, and thereby transforms the facial feature.

Further, the reconstruction unit 303 inputs the facial feature transformed by the MLP 402 to Reshape 903 in which processing for matrix shape transformation (shape transformation that accords with the shape of the intermediate feature) is performed and performs computational processing of Reshape 903, and thereby transforms the facial feature into a facial feature obtained by increasing the number of dimensions of the facial feature, similar to Reshape 403.

Then, the reconstruction unit 303 inputs the facial feature transformed by Reshape 903 and the intermediate feature of the ResNet 401 to concatenate 704 and performs computation of concatenate 704. The reconstruction unit 303 thereby generates, as an “optimized feature”, concatenated information obtained by concatenating the facial feature transformed by Reshape 903 and the intermediate feature of the ResNet 401.

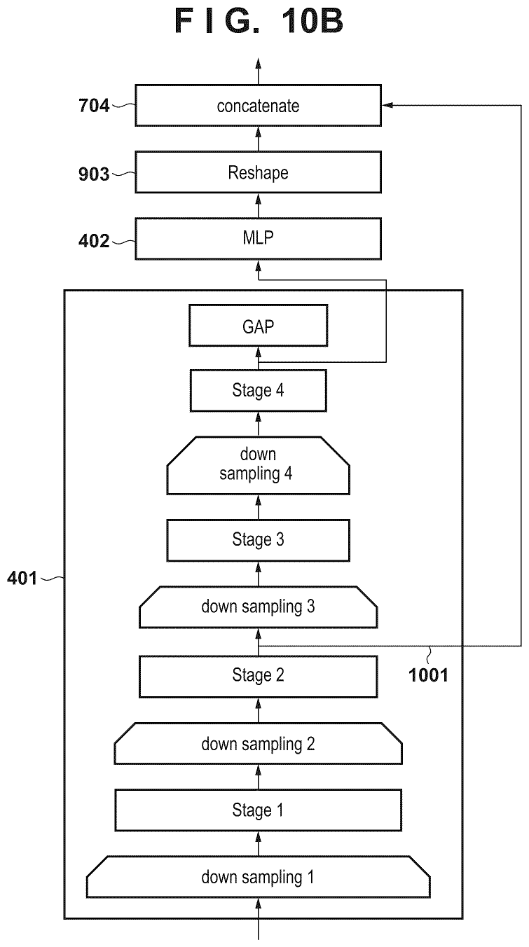

The transformation unit 304 inputs the feature generated by concatenate 704 to the VIT 705 and performs computational processing of the VIT 705, and thereby transforms the feature. Here, a method of obtaining an intermediate feature of the ResNet unit 401 will be described with reference to FIG. 10A. First, the ResNet unit 401 is a network that gradually reduces the resolution of an input image, as described in K. He, X. Zhang, S. Ren, and J. Sun, “Identity mappings in deep residual networks”, ECCV, 2016. In each stage indicated in FIG. 10A, feature transformation processing, such as convolution and normalization, and pooling, is performed, and in each down sampling, a convolution filter with a stride of 2 or more is applied, and thereby, the resolution of an input image is reduced. Here, it is assumed that an intermediate feature of Stage 2 is passed to the subsequent concatenate 704 by shortcut connection 1001.

Further, a feature inputted to the reconstruction unit 303 need not necessarily be outputted from the final layer of the transformation unit 302. For example, as illustrated in FIG. 10B, an intermediate feature immediately before Global Average Pooling (GAP) is applied may be inputted to the reconstruction unit 303. The use of a feature with abundant amount of information prior to compression by GAP makes it possible to improve the accuracy of processing of the neural network. As such, a feature to be inputted to the reconstruction unit 303 is not limited to a one-dimensional tensor.

Similar to the above embodiments, the above neural network is treated as one feature transformation model that obtains a face image and uses output from the transformation unit 304 as final output to perform collation, and training and inference methods conform to the above embodiments.

Finally, effects of the present embodiment will be described. In the present embodiment, in addition to the effects obtained in the above embodiments, an intermediate feature of a trained model is reused, and thereby redundancy of processing of a neural network is prevented and efficiency of processing of the neural network is improved.

### Fourth Embodiment

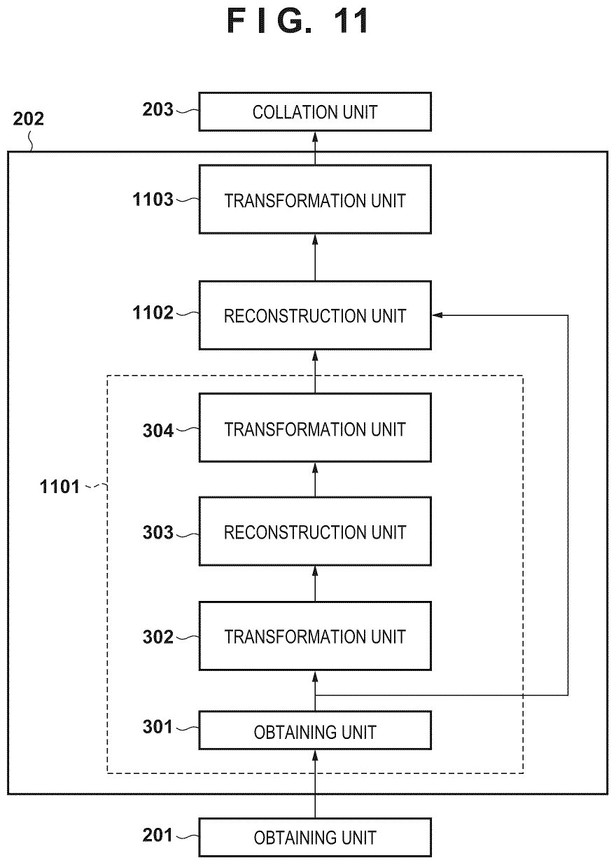

An example of a configuration of the computation unit 202 according to the present embodiment will be described with reference to a block diagram of FIG. 11. As illustrated in FIG. 11, the computation unit 202 according to the present embodiment includes a transformation unit 1101, which has a configuration similar to that of the computation unit 202 illustrated in FIG. 3; a reconstruction unit 1102; and a transformation unit 1103.

The reconstruction unit 1102 obtains a face image generated by the obtaining unit 301 by shortcut connection. Then, the reconstruction unit 1102 transforms a feature that is an output from the transformation unit 1101 and generates, as a feature, concatenated information obtained by concatenating the transformed feature and the face image generated by the obtaining unit 301.

The transformation unit 1103 inputs the feature generated by the reconstruction unit 1102 to a neural network and performs computational processing of the neural network, and thereby applies feature transformation processing on the feature. With this, the feature according to the transformation unit 1101 is transformed into a feature with reduced loss in feature extraction.

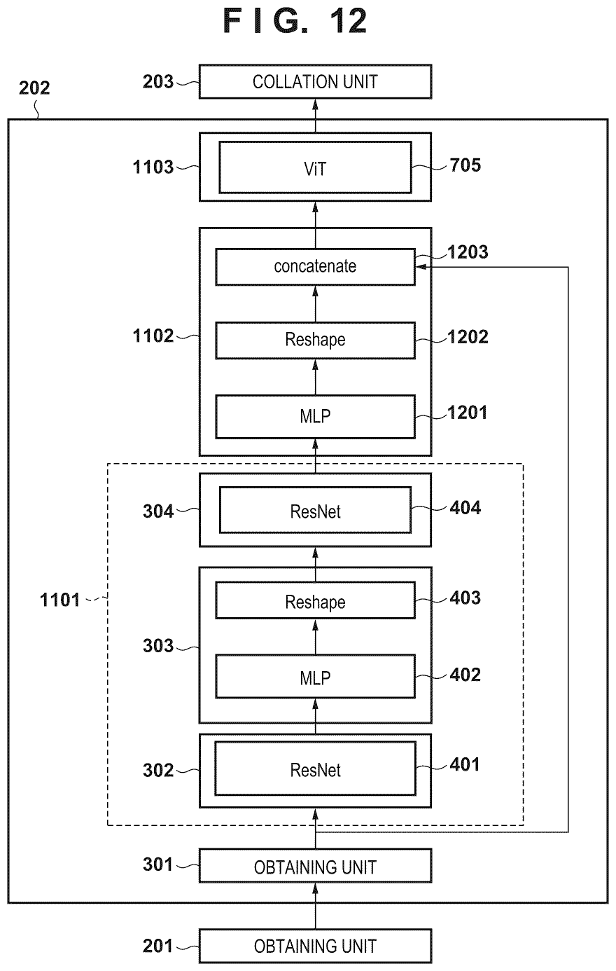

A specific example of a neural network according to the present embodiment will be described with reference to FIG. 12. In the first embodiment, collation is performed using a feature outputted from the ResNet 404; however, in the present embodiment, feature transformation is further applied to that feature. For further feature transformation, the reconstruction unit 1102 is used.

The reconstruction unit 1102 inputs a feature calculated by the transformation unit 1101 to an MLP 1201, which is similar to the MLP 402, and performs computational processing of the MLP 1201, and thereby transforms the facial feature. Then, the reconstruction unit 1102 inputs the facial feature transformed by the MLP 1201 to Reshape 1202, which is similar to Reshape 403, and performs computational processing of Reshape 1202, and thereby transforms the facial feature. Then, the reconstruction unit 1102 inputs the facial feature transformed by Reshape 1202 and the facial image generated by the obtaining unit 301 to concatenate 1203, which is similar to concatenate 704, and performs computation of concatenate 1203. The reconstruction unit 1102 thereby generates, as an “optimized feature”, combined information obtained by combining the facial feature transformed by Reshape 1202 and the facial image generated by the obtaining unit 301.

The reconstruction unit 1102 obtains a face image generated by the obtaining unit 301 by shortcut connection. This shortcut connection has an effect of restoring features that are lost as feature transformation processing is repeated and reducing loss in feature extraction.

The transformation unit 1103 inputs the feature generated by concatenate 1203 to the VIT 705 and performs computational processing of the VIT 705, and thereby transforms the feature.

Next, methods of inference and training of the neural network according to the present embodiment will be described. The transformation unit 1101 is a neural network obtained by the method of the first embodiment. In the first embodiment, the ResNet 401 is first trained as an independent neural network, and then, the MLP 402, Reshape 403, and the ResNet 404 are applied; thereafter, these are trained as one neural network, but at that time, weights of the ResNet 401 are fixed and not updated. The transformation unit 1101 is thus obtained.

Then, the reconstruction unit 1102 and the transformation unit 1103 are applied to the transformation unit 1101; thereafter, these are trained as one neural network, but at that time, weights of the transformation unit 1101 are fixed and not updated. The reconstruction unit 1102 and the transformation unit 1103 are thus trained.

At the time of inference, a face image is inputted to the transformation unit 1101, and output of the transformation unit 1103 is assumed as a final output feature. The collation unit 203 of FIG. 2 performs collation using the final output feature. In the present embodiment, an example in which the ResNet 401, the transformation unit 1101, the reconstruction unit 1102, and the transformation unit 1103 are trained in three stages has been described; however, the present disclosure is not limited thereto. For example, they may be trained all at once. Further, for example, a configuration may be taken so as to first train only the ResNet 401 and then train the transformation unit 1101 and the transformation unit 1103. Further, for example, a configuration may be taken so as to further add the transformation unit 1103 and perform training in stages or all at once.

Finally, effects of the present embodiment obtained in addition to effect of the above embodiments will be described. In the present embodiment, it is possible to train an output feature of an existing neural network in stages. Compared with a case where a large neural network is trained in one go, an effect of reduction in the number of parameters to be trained at a time and facilitating training can be expected.

Further, when there are features that are missed in the transformation unit 302, features are complemented by shortcut connection. The subsequent transformation unit performs feature transformation in which a missed feature and a high-dimensional feature obtained in the previous stage are mixed, and thereby transforms the high-dimensional feature obtained in the previous stage into a more efficient feature. As described above, according to the present embodiment, by feature transformation being repeated many times in stages, it is possible to increase the accuracy of processing of the neural network.

### Fifth Embodiment

Essential points of each of the above embodiments are to combine local and stepwise feature transformation, such as a CNN, and feature transformation with a high degree of freedom for a spatial direction, such as an MLP, and efficiently integrate local and global features. There may be various forms that satisfy this condition. For example, in the first embodiment, an input image is transformed by a CNN and then transformed into a high-resolution feature by an MLP, but a form in which this order is reversed is also conceivable. Specifically, a form such as that in which an input image is first transformed into a feature vector by an MLP and then gradually transformed into a high-resolution feature by a plurality of instances of a deconvolution layer can be given.

As another form, a form obtained by partially modifying a pyramid feature network, a stacked hourglass network, a UNet of Ronneberger et. al., “U-Net: Convolutional Networks for Biomedical Image Segmentation”, arXiv: 1505.04597, and the like are considered. In all the above networks, a convolution layer, which reduces spatial resolution, and a deconvolution layer (or an upsampling layer), which increases spatial resolution, are symmetrically arranged. In the present embodiment, a network in which a part or all of the convolution layer or the deconvolution layer is replaced with an MLP layer can be considered. Conceptually, two stages of convolutional layers, which reduce spatial resolution, are arranged, and the resolution is restored in the middle of the network. Such a network may be able to realize similar inference performance with less computation load than that prior to configuration modification. As another form, a form that includes, between the layer that reduces spatial resolution and the layer that increases spatial resolution described above, a plurality of feature transformation layers that do not change spatial resolution can be considered.

Further, in the above embodiments, image recognition has been mainly described, but the present disclosure is not limited thereto and may be applied to natural language processing, voice recognition, and the like. The present disclosure is widely applicable so long as the neural network processes data that has a spatial arrangement relationship or an ordinal relationship.

Further, in the above embodiments, the transformation unit and the reconstruction unit change the size of an image feature in a spatial direction when processing an image. When applying to an information processing apparatus that processes document data, it is conceivable to change feature elements corresponding to words constituting the document by, for example, integration. Further, when applying to a form in which time series data, such as a moving image or audio, is processed, it is conceivable to change elements of a feature corresponding to a time direction. Accordingly, various kinds of information such as images, audio, and documents, can be applied as input information to be inputted to the neural network.

As described above, an information processing apparatus that includes a first computation unit, which performs first transformation, which is a local multi-stage feature transformation, and a second computation unit, which performs second transformation (feature transformation in which the number of elements and the number of dimensions of a feature is changed in a direction of increase/decrease different from that of the first transformation), which is feature transformation that is wider than that of the first transformation, is applicable to various applications.

The numerical values, processing timing, processing order, processing entity, data (information) configuration/obtainment method/transmission destination/transmission source/storage location, and the like used in each of the embodiments described above have been given as examples for the sake of providing a concrete explanation, and it is not intended to be limited to such examples.

Further, some or all of the embodiments described above may be appropriately combined and used. Further, some or all of the embodiments described above may be selectively used.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-014302, filed Feb. 1, 2024, which is hereby incorporated by reference herein in its entirety.

What is claimed is:

1. An information processing apparatus comprising one or more processors; and one or more memories storing executable instructions which, when executed by the one or more processors, cause the information processing apparatus to function as:
a first computation unit configured to perform local multi-stage feature transformation as a first transformation; and
a second computation unit configured to perform feature transformation wider than the first transformation as a second transformation,
wherein, in the second transformation, at least one of a number of elements and a number of dimensions of a transformed feature are different from that of the first transformation.

2. The information processing apparatus according to claim 1, wherein
the first computation unit is further configured to perform computational processing in a neural network into which input information has been inputted and to calculate a one-dimensional tensor feature.

3. The information processing apparatus according to claim 2, wherein
the second computation unit is further configured to perform linear transformation in which a number of elements of the one-dimensional tensor feature is increased and to calculate a three-dimensional feature by rearrangement of elements of a feature obtained by the linear transformation.

4. The information processing apparatus according to claim 3, wherein
the second computation unit is further configured to perform the linear transformation by using a fully-connected layer.

5. The information processing apparatus according to claim 3, wherein
the second computation unit is further configured to calculate, as a feature, information in which the three-dimensional feature and the input information are merged.

6. The information processing apparatus according to claim 3, wherein
the second computation unit is further configured to calculate, as a feature, information in which two features in the first computation unit are merged.

7. The information processing apparatus according to claim 6, wherein
the two features are a feature of a final layer in the first computation unit and an intermediate feature in the first computation unit.

8. The information processing apparatus according to claim 6, wherein
the two features are two intermediate features in the first computation unit.

9. The information processing apparatus according to claim 1, wherein the one or more processors are further programmed to cause the information processing apparatus to function as:
a third computation unit configured to perform computational processing in a hierarchical neural network to which a feature obtained by the second computation unit has been inputted and to calculate a one-dimensional tensor feature.

10. The information processing apparatus according to claim 9, wherein
a number of layers in a hierarchical neural network used by the first computation unit is greater than a number of layers of the hierarchical neural network used by the third computation unit.

11. The information processing apparatus according to claim 9, wherein the one or more processors are further programmed to cause the information processing apparatus to function as:
a collation unit configured to perform collation between a feature calculated by the third computation unit for one piece of input information and a feature calculated by the third computation unit for another piece of input information.

12. The information processing apparatus according to claim 9, wherein the one or more processors are further programmed to cause the information processing apparatus to function as:
a fourth computation unit configured to transform a feature calculated by the third computation unit and to calculate, as a feature, information in which the transformed feature and input information have been merged; and
a fifth computation unit configured to perform computational processing in a hierarchical neural network to which the feature calculated by the fourth computation unit has been inputted and to calculate a one-dimensional tensor feature.

13. The information processing apparatus according to claim 12, wherein the one or more processors are further programmed to cause the information processing apparatus to function as:
a collation unit configured to perform collation between a feature calculated by the fifth computation unit for one piece of input information and a feature calculated by the fifth computation unit for another piece of input information.

14. The information processing apparatus according to claim 5, wherein
the merging includes at least one of concatenation, element-wise multiplication, and addition.

15. The information processing apparatus according to claim 11, wherein the one or more processors are further programmed to cause the information processing apparatus to function as:
a training unit configured to train the second computation unit and the third computation unit based on a feature calculated by the third computation unit.

16. The information processing apparatus according to claim 9, wherein
the hierarchical neural network includes a ResNet and a Vision Transformer.

17. An information processing method performed by an information processing apparatus, the method comprising:
performing a local multi-stage feature transformation as a first transformation; and
performing feature transformation wider than that of the first transformation as a second transformation,
wherein, in the second transformation, at least one of a number of elements and a number of dimensions of a transformed feature are different from that of the first transformation.

18. A non-transitory computer-readable storage medium storing a computer program that, when executed by a computer, causes the computer to function as:
a first computation unit configured to perform a local multi-stage feature transformation as a first transformation; and
a second computation unit configured to perform feature transformation wider than that of the first transformation as a second transformation,
wherein, in the second transformation, at least one of a number of elements and a number of dimensions of a transformed feature are different from that of the first transformation.
